(19) United States
(12) Patent Application Publication
(10) Pub. No.: US 2018/0321730 A1
(43) Pub. Date: Nov. 8, 2018

(54) METHODS FOR ADAPTIVE BATTERY CHARGING AND ELECTRONIC DEVICE THEREOF

(71) Applicant: Samsung Electronics Co., Ltd., Suwon-si (KR)

(72) Inventors: Aravinda Reddy MANDLI, Bengaluru (IN); Sanoop RAMACHANDRAN, Bengaluru (IN); Ashish KHANDELWAL, Bengaluru (IN); Ki Young KIM, Yongin-si (KR)

(21) Appl. No.: 15/593,924

(22) Filed: May 12, 2017

(30) Foreign Application Priority Data
May 4, 2017 (IN) 201641016546

(51) Int. Cl. G06F 1/32; H02J 7/00; G06F 1/26

(52) U.S. Cl. CPC G06F 1/3212; G06F 1/3296; G06F 1/263; H02J 7/007

(57) ABSTRACT

A method for adaptive battery charging and an apparatus therefor are disclosed. The present disclosure relates to a battery system for electronic devices and more particularly to the rate of charging of batteries in electronic devices. The method and apparatus are directed to dynamically determining the charging rate of a battery of an electronic device, based on factors such as user profile, usage, age of battery, etc. The method discloses determining at least one charging rate for a battery, determining at least one model representing an effect of degradation of the battery and a charging time for at least one charging mechanism, determining charging profiles over a cycle life of the battery based on the at least one model, and applying the charging profiles to the battery.

### CROSS-REFERENCE TO RELATED APPLICATION(S)

This application claims the benefit under 35 U.S.C. § 119(a) of an Indian Provisional patent application filed on May 12, 2016 in the Indian Patent Office and assigned Serial number 201641016546 and an Indian patent application filed on May 4, 2017 in the Indian Patent Office and assigned Serial number 201641016546, the entire disclosure of each of which is hereby incorporated by reference.

### TECHNICAL FIELD

The present disclosure relates to the field of battery system for electronic devices. More particularly, the present disclosure relates to the charging of batteries in electronic devices.

### BACKGROUND

Users use electronic devices for multiple purposes. For example, smart phones provide support for multiple applications such as but not limited to image/audio/video recording, navigation, social networking, multimedia playback, general Internet browsing, and so on. Though a single device with multiple application support is quite convenient from a user perspective, it can affect the battery life of the device adversely. Also, more the number of applications running on the device, the power consumption would also increase. The battery performance can also be affected by additional factors such as age, charging rates, and so on.

Devices currently use charging mechanisms such as constant current-constant voltage (CCCV), multi-stage CCCV (MSCC) for charging batteries. The mechanisms in a standard charging profile charges the battery at a fixed constant current (CC) to a specified cutoff voltage (CV), then charges the battery at the specified CV. In a fast charging profile, the mechanism uses a higher charging current or use two or more CC phases. There are solutions available wherein a user can choose between a standard charge profile and a fast charge profile. When unspecified, standard charging is used throughout the life of battery to charge a battery. Fast charging can dramatically reduce the battery life. Current solutions use a constant rate to meet battery warranty specifications.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide methods and systems for dynamically determining charging rate of a battery of an electronic device, based on factors such as user profile, usage, age of battery, and so on.

In accordance with an aspect of the present disclosure, a method for operating an electronic device is provided. The method includes determining at least one charging rate for a battery, determining at least one model representing an effect of degradation of the battery and a charging time for at least one charging mechanism, determining a plurality of charging profiles over a cycle life of the battery based on the at least one model, and applying the plurality of charging profiles to the battery.

In accordance with an aspect of the present disclosure, an electronic device is provided. The electronic device includes a battery, and at least one processor configured to determine at least one charging rate for the battery, determine at least one model representing an effect of degradation of the battery and a charging time for at least one charging mechanism, determine a plurality of charging profiles over a cycle life of the battery based on the at least one model, and apply the plurality of charging profiles to the battery.

In accordance with an aspect of the present disclosure, an electronic device is provided. The electronic device includes a battery, and at least one processor configured to choose a plurality of charging rates for a duration over a life of the battery, determine a plurality of charging profiles corresponding to the plurality of charging rates, adapt at least one of the plurality of charging profiles based on at least one of a battery age, a charging time and a user input, and apply, to the battery, the plurality of charging profiles including the adapted at least one of the plurality of charging profiles for the duration.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device according to an embodiment of the present disclosure;

FIG. 2 illustrates an example user interface, wherein the user can set options related to the charging of the device, according to an embodiment of the present disclosure;

FIG. 3 is a flowchart depicting the process of determining charging rates for a battery in an electronic device according to an embodiment of the present disclosure;

FIG. 4 is a flowchart depicting the process of determining charging rates for a battery in an electronic device and applying the determined charging rates to the battery according to an embodiment of the present disclosure;

FIGS. 5A, 5B, 5C, and 5D illustrate example scenarios depicting the advantages of adaption of different charging profiles for charging the battery over time according to various embodiments of the present disclosure;

FIGS. 6A, 6B, 6C, and 6D illustrate example scenarios depicting the advantages of adaption of different charging profiles for charging the battery over time according to various embodiments of the present disclosure;

FIGS. 7A, 7B, 7C, and 7D illustrate example scenarios depicting the advantages of adaption of different charging profiles for charging the battery over time according to various embodiments of the present disclosure;

FIGS. 8A, 8B, 8C, and 8D illustrate example scenarios depicting the advantages of adaption of different charging profiles for charging the battery over time according to various embodiments of the present disclosure;

FIGS. 9A, 9B, 9C, and 9D illustrate example scenarios depicting the improvement of cycle life due to the adoption of different charging profiles for charging the battery over time according to various embodiments of the present disclosure; and

FIGS. 10A, 10B, 10C, and 10D illustrate example scenarios depicting the advantages of adaption of different charging profiles for charging the battery over time according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

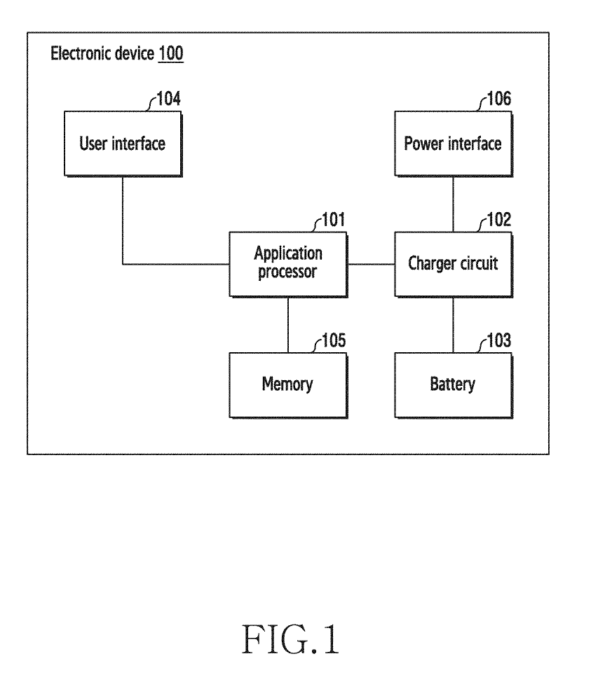

The various embodiments herein disclose methods and systems for dynamically determining charging rate of a battery of an electronic device, based on factors such as user profile, usage, age of battery, and so on. Referring now to the drawings, and more particularly to FIGS. 1 through 10D, where similar reference characters denote corresponding features consistently throughout the figures, there are shown example embodiments.

The electronic device as disclosed herein can be any device comprising of at least one chargeable battery. Examples of the device can be, but not limited to, mobile phones, smart phones, tablets, computers, laptops, wearable devices, internet of things (JOT) devices, and so on.

FIG. 1 illustrates an electronic device according to an embodiment of the present disclosure.

Referring to FIG. 1, the electronic device 100, as depicted, comprises of an application processor 101 (i.e., at least one processor), a charger circuit 102, at least one battery 103, at least one user interface 104, and a memory (or memory module) 105. The electronic device 100 can comprise of at least one power interface 106, wherein the power interface 106 can be connected to at least one power source, wherein the power source can be used to charge the battery 103. The power interface 106 can use at least one of a wired or a wireless means for charging the battery 103.

A battery charging system according to the present disclosure operates following descriptions. First, a user inputs can be provided to the user interface 104. User inputs can comprise short term preferences (such as, charge time, duration) and long term preferences (such as, life, duration of high performance). Second, models can be determined by referring the user inputs or environments, conditions about battery charging. For example, an empirical model can be determined in the charging system. Third, optimization can be performed based on the determined models. In this process, optimization problems are solved to minimize weighted charging time (over life). As a result, an optimal charging protocol can be used for solving the optimization problems.

The user interface 104 can enable a user of the electronic device 100 to interact with the device 100. The user interface 104 can enable the user to provide inputs to the device 100, such as configuring at least one option related to the charging of the battery 103. The user interface 104 can also enable the user to configure at least one option such as time of expected high performance, requests for a desired charging time, and so on.

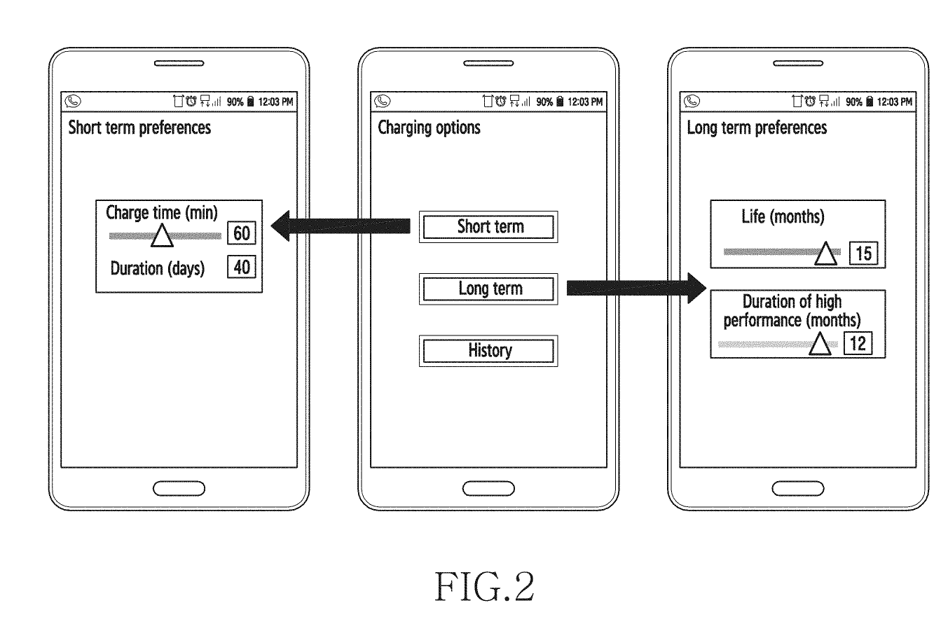

FIG. 2 illustrates an example user interface according to an embodiment of the present disclosure, wherein the user can set options related to the charging of the device 100 such as short-term options (for example, the time required to charge the battery for a specified number of days), and long-term options (such as the minimum required life of the battery, duration of high performance and so on). The user interface can also enable the user to view additional information such as charging history, and so on.

The memory (or memory module) 105 can be configured to store data related to the charging, such as charging profiles, user options, charging history, and so on.

The application processor 101 can be configured to determine an ageing parameter of the battery 103, wherein the ageing parameter indicates an ageing factor of the battery 103. The application processor 101 can be further configured to host multiple charging profiles, which can be used to vary the way in which the battery 103 can be charged, over the life of the battery. Each of the charging profiles includes at least one parameter for controlling a charging operation of the battery. The charging profiles can be determined by many factors. The charging profiles can be dependent on factors such as user configured options, battery test data for various charging profiles, battery models for degradation and charging times, manufacturer warranty specs, state of health, ageing factor, and so on. The application processor 101 further comprises empirical models that capture battery degradation and charging time for each of the charging profiles. The model represents properties of environments or conditions related the battery charging, and are used as criteria to determine the charging profiles. For instance, as the models, empirical models may be employed. The empirical models are any kind of models based on empirical observation rather than on mathematically describable relationships of the system model.

In an example, for a particular constant current-constant voltage (CCCV) charging rate I at solid-electrolyte interface (SEI) film thickness δₙ, an ageing parameter which indicates battery degradation, the growth of film thickness in a single cycle can be modeled as:

Δδₙ^{(I,δ}^{ₙ}⁾=Δδₙ₀^{(I)}exp(f_{I}(δₙ)) Equation 1

In the equation above, Δδₙ^{(I,δ}^{ₙ}⁾ is the growth of film thickness, Δδₙ₀^{(I)} is the growth of film thickness in the first cycle at that current rate and the function f_{I}(δₙ) is modeled using polynomial expressions. To obtain f_{I}(δₙ), a physics based model termed hybrid simplified electrochemical model (HSEM) is simulated at various δₙ for a particular CCCV current I, accounting for the variation of Cₙ₀, Cₚ₀ with δₙ, to compute log (Δδₙ^{(I,δ}^{ₙ}⁾/Δδₙ₀^{(I)}). f_{I}(δₙ) is then obtained as the model fit of log (Δδₙ^{(I,δ}^{ₙ}⁾/Δδₙ₀^{(I)}) vs δₙ as:

$$\begin{matrix}{f}_{I} ( {δ}_{n} ) = log ( {Δδ}_{n}^{( I , {δ}_{n} )} / {Δδ}_{n 0}^{( I )} ) \\ = {a}_{0} + {a}_{1} ( \frac{{δ}_{n}}{c} ) + {{a}_{2} ( \frac{{δ}_{n}}{c} )}^{2} + … + {{a}_{k} ( \frac{{δ}_{n}}{c} )}^{k}\end{matrix} \qquad Equation 2$$

In the equation above, a₀, a₁, a₂, . . . , aₖ are model coefficients, k is the degree of the polynomial and c is a normalization constant. The fits of empirical models for SEI film growth at various CCCV charging currents are obtained. In an embodiment herein, polynomials of degree 3 can be considered sufficient to accurately fit the data generated using the HSEM.

Similarly, the charge time for CCCV charging rate I at film thickness δₙ is modeled as:

t^{(I,δ}^{ₙ}⁾=t₀^{(I)}+g_{I}(δₙ) Equation 3

In the equation above, t^{(I,δ}^{ₙ}⁾ is the charge time, t₀^{(I)} is the charge time in the first cycle at that current rate and g_{I}(δₙ) are modeled as polynomial expressions. Similar to the above case, g_{I}(δₙ) are obtained as model fits of t^{(I,δ}^{ₙ}⁾−t₀^{(I)} vs δₙ for data generated using HSEM. The fits of empirical models for charge time at 8 different CCCV charging currents obtained. Similar to the case of SEI film growth, polynomials of degree 3 can be considered sufficient to accurately fit the charge time data generated using the HSEM and hence, these are used for further computations.

The empirical models can be used to predict the capacity fade and charging time when the battery is cycled at various C-rates. The growth of δₙ in the cycle i+1 is calculated as:

δₙ₍ᵢ₊₁₎=δₙ₍ᵢ₎+Δδₙ^{I,δ}^{ₙ₍ᵢ₎}⁾ Equation 4

whereas the charging time in cycle i+1 is calculated using:

tᵢ₊₁=t₀^{(I)}+g_{I}(δₙ₍ᵢ₎) Equation 5

The predictions of the empirical models of the capacity fade and charging time are compared against model simulation results of HSEM at two different charging rates 1C and 2C. The results show that the empirical models can accurately predict the capacity fade and charging time. The computational time required for simulating 500 cycles by both HSEM and empirical models ˜17 minutes and ˜50 ms respectively. Hence, the empirical models are substantially faster compared to HSEM model and can be used for optimization studies.

The optimal charging profile over cycle life can be determined using empirical models that represent charging time and degradation behavior of various charging profiles. In an embodiment herein, the application processor 101 can solve an optimization problem that considers user preferences and manufacturer warranty specifications and minimizes a weighted average of charging time over the cycles. An optimization algorithm is lightweight and easy to implement on-board without additional hardware. In an embodiment herein, the application processor 101 can solve an optimization problem that considers user preferences and manufacturer warranty specifications and minimizes a deviation from a standard charging time of charging time over the cycles. The application processor 101 can solve the optimization problem using any suitable method such as deterministic methods (such as gradient based) or stochastic methods (such as genetic algorithm (GA), particle swarm optimization (PSO), and so on).

Consider an example wherein there are n charging cycles with C-rates (2, 2, . . . , 1) and charge time (t₁, t₂, . . . tₙ) respectively. The objective of optimization can comprise of minimizing the weighted average of charging time over the pre-defined number of charging cycles and can be defined as:

Objective=Min Σᵢ₌₁ⁿwᵢtᵢ,

subject to
the growth of SEI is a degradation measure (δ) and is defined as

δᵢ₊₁=δᵢ+dδ(c−rate,δᵢ)
the charging time of cycle i defined as:

tᵢ=t₀(C−rate)+dt(C−rate,δᵢ); and
wherein the limit on the thickness of the SEI is:

δₙ≤δₘₐₓ

In the equations above, tᵢ is the charge time at cycle i, wᵢ is the weight assigned to the charging time of cycle i, and N is the total number of cycles.

On solving the problem, the application processor 101 can determine a sequence of charging rates/profiles over the life of the battery that minimizes the objective over the cycle life while meeting warranty specifications. The algorithm can be run at various battery ages to determine the optimal charging protocol from that time.

The application processor 101 can be configured to determine or select at least one battery profile that matches the determined ageing parameter of the battery 103, and then apply the selected profile(s) to charge the battery 103. The application processor 101 can select the charging profile, so as to minimize weighted charge time (over the life of the battery) subject to battery model for charge time and degradation. The application processor 101 can be configured to determine the order in which selected profiles are to be applied. The application processor 101 can also determine a switching interval between the selected profiles, in a multi-profile charging scenario. In an embodiment, the application processor 101 can determine in real-time, the ageing factor of the battery, and accordingly change the order in which the selected profiles are applied as well as the switching interval.

In another embodiment of the present disclosure, the application processor 101 can be configured to consider at least one of real-time usage parameter information and a real-time user input for determining the optimum profile(s). The usage parameter can indicate the real-time battery consumption details. For example, if multiple applications in the electronic device 100 are being used at the time of charging, then the battery consumption increases accordingly. Upon receiving this information, the application processor 101 can accordingly select an optimal rate of charging.

In addition, the application processor 101 can be configured to provide at least one option for a user to customize the charging profiles, using the user interface 104. The application processor 101 can also use information such as age group of the user, vocation/profession of the user, his usage habits (comprising of usage history, predicted usage, and so on), his geographic location, and so on, to select the charging profiles.

In an embodiment of the present disclosure, the application processor 101 can apply the charging profiles in any charging scheme/mechanism, such as CCCV, multistage constant current (MSCC), linearly decreasing current (LDC), pulsed charging, constant current+pulsed charging (CCPC), pulse charging (PC), variable voltage (VV), constant power (CP), boost charging (BC), and so on. In an embodiment herein, the application processor 101 can apply the charging profiles in mixed charging schemes, wherein more than one charging schemes are used.

In an embodiment of the present disclosure, the application processor 101 can be located outside the electronic device 100, wherein the application processor 101 can control the charging of the battery 103 using the charger circuit 102. The application processor 101 can be located in a charger connected to the device 100 (either by wired or wireless means), in a network wherein the device 100 is connected to the network, in an internet of things (IoT) device in a network to which the device 100 is connected, and so on.

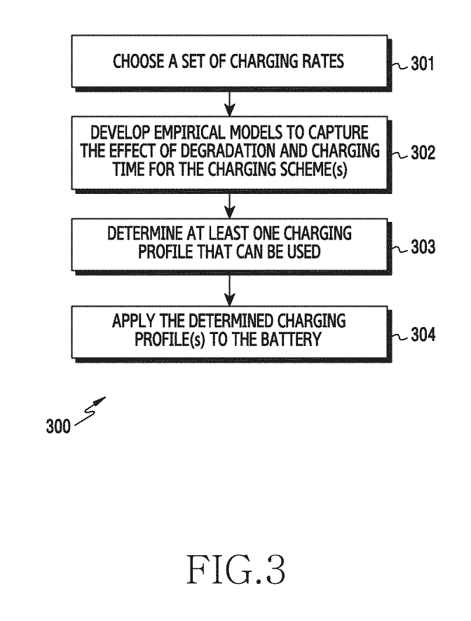

FIG. 3 is a flowchart depicting the process of determining charging rates for a battery in an electronic device according to an embodiment of the present disclosure.

Referring to FIG. 3, a set of charging rates (C₁, C₂, . . . , Cₙ) are determined at operation 301 for the charging scheme(s). The set of charging rates can be determined by the application processor 101, or by an external device, either online or offline. The set of charging rates can depend on experimental results/simulations based on factors such as type of battery, battery capacity, and so on. Empirical models (such as fast polynomial models) are developed at operation 302 to capture the effect of degradation and charging time for the charging scheme(s). The empirical models can be determined by the application processor 101, or by an external device, either online or offline. The empirical models can be based on factors such as charge time, change in ageing parameter (based on factors such as the current ageing parameter, and so on). The application processor 101 can cycle test batteries at each of the charging rate to determine charge time and ageing parameter. The application processor 101 determines at operation 303 the optimal charging profiles over the cycle life, using the empirical models, wherein the charging profiles can comprise of a set of charging rates. The application processor 101 can determine the optimal charging profiles by performing optimization considering factors such as weighted charging time, battery age, user options, real-time usage parameters, real-time user input, temperature, and so on. The application processor 101 can determine the charging rate, based on constraints depending on the battery 103, the power source(s), and as set by the user. The application processor 101 can determine more than one charging rate, an order for applying the determined charging rates, and so on. The application processor 101 can use the optimization algorithm to determine the sequence of charging rates that maximize user satisfaction while meeting constraints. The application processor 101 then applies at operation 304 the determined charging rates to the battery 103, using the charger circuit 102. The various actions in method 300 may be performed in the order presented, in a different order or simultaneously. Further, in some embodiments, some actions listed in FIG. 3 may be omitted.

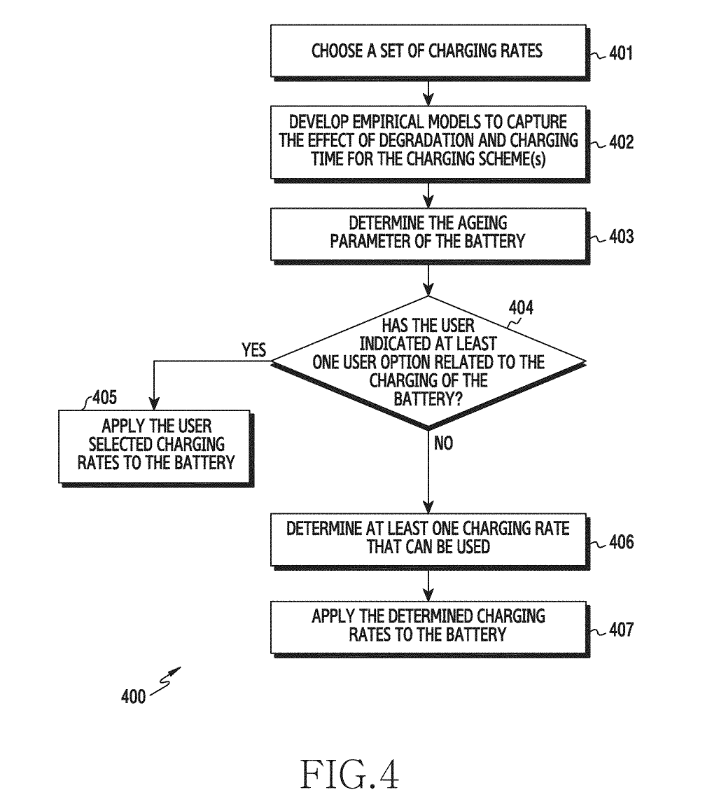

FIG. 4 is a flowchart illustrating the process of determining charging rates for a battery in an electronic device and applying the determined charging rates to the battery according to an embodiment of the present disclosure.

Referring to FIG. 4, the application processor 101 chooses at operation 401 a set of charging rates (C₁, C₂, . . . , Cₙ) for the current charging scheme. The application processor 101 develops at operation 402 empirical models to capture the effect of degradation and charging time for the charging scheme(s). The application processor 101 can cycle test batteries at each of the charging rate to determine charge time and ageing parameter. The application processor 101 determines at operation 403 the ageing parameter of the battery 103. The application processor 101 checks at operation 404 if the user has indicated at least one user option related to the charging of the battery 103, wherein the user option can comprise of a charging rate. If the user has indicated at least one user option related to the charging of the battery 103, the application processor 101 applies at operation 405 the user selected charging rate. If the user has not indicated at least one user option related to the charging of the battery 103, the application processor 101 determines at operation 405 at least one charging rate that can be used. The application processor 101 can determine the charging rate by performing optimization considering factors such as weighted charging time, battery age, user options, real-time usage parameters, real-time user input, temperature fluctuations, and so on. The application processor 101 can adapt the charging rates, based on the determined ageing parameter. The application processor 101 can determine the charging rate, based on constraints depending on the battery 103, the power source(s), and as set by the user. The application processor 101 can determine more than one charging rate, an order for applying the determined charging rates, and so on. The application processor 101 can use the optimization algorithm to determine the sequence of charging rates that maximize user satisfaction while meeting constraints. The application processor 101 applies at operation 406 the first charging rate to the battery 103 and applies at operation 407 the determined charging rate(s) to the battery (and/or re-determines at operation 407 the ageing parameter). The application processor 101 can check whether the battery has completely aged. If the battery has completely aged, the process may finish. If the battery has not completely aged, the application processor 101 may checks (404) whether the user has indicated at least one user option related to the charging of the battery 103, and above processes are repeated. The various actions in method 400 may be performed in the order presented, in a different order or simultaneously. Further, in some embodiments, some actions listed in FIG. 4 may be omitted.

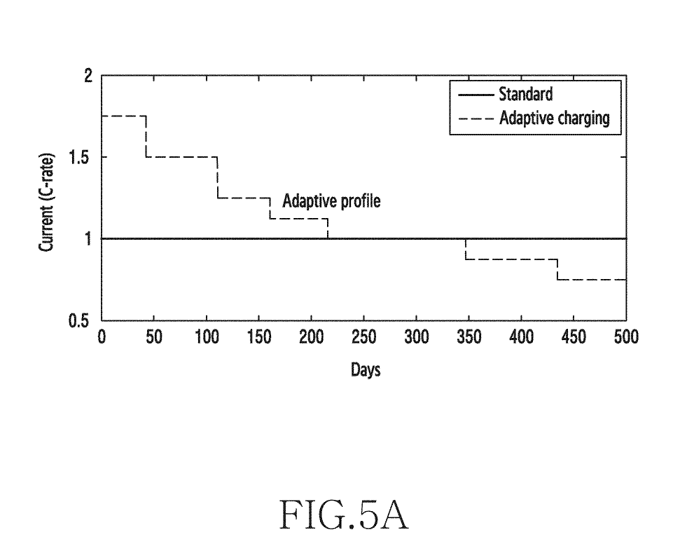

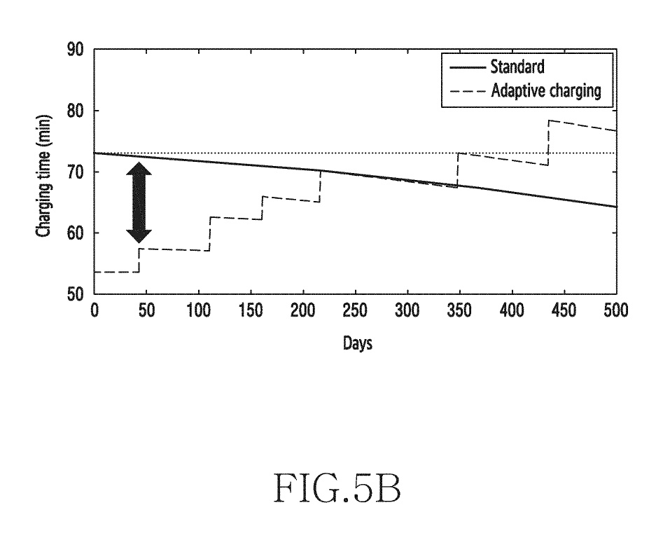

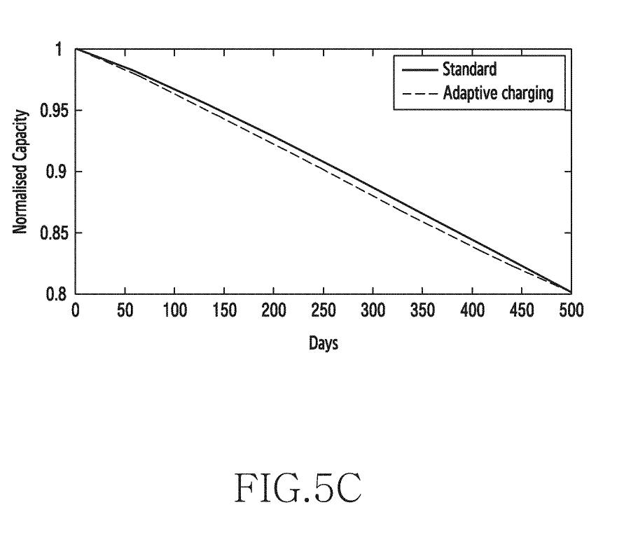

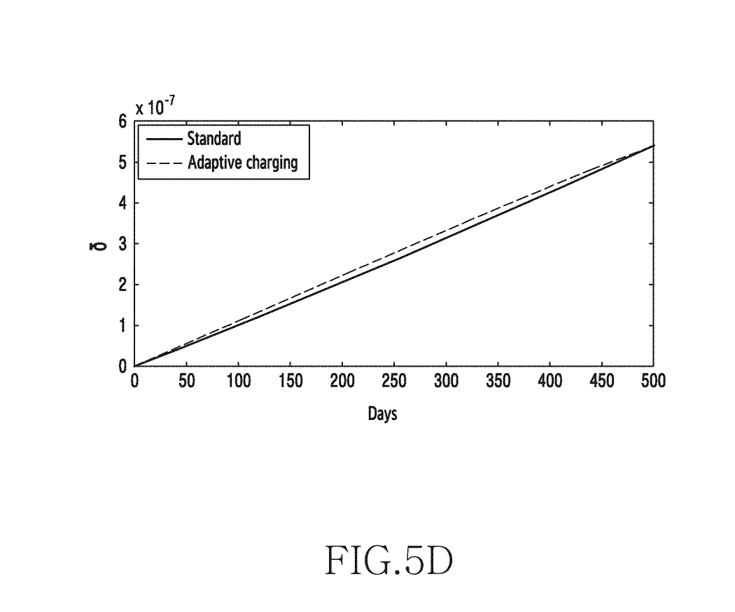

FIGS. 5A, 5B, 5C, and 5D illustrate example scenarios depicting the advantages of adaption of different charging profiles for charging the battery over time according to various embodiments of the present disclosure.

Referring to FIGS. 5A to 5D, here it is considered that battery 103 is put through 1 charge/discharge cycle per day. The user is considered to assign equal priority to the charging time of all the days (500, in this example) and the batteries are cycled for 500 days. FIG. 5A illustrates the optimal charging profile over cycle life of the battery. It can be computed from FIG. 5B that the average charging time for 500 days using standard CCCV protocol is approximately 69.24 minutes. It can be computed from FIG. 5B that the average charging time for 500 days using various embodiments as disclosed herein (also referred to as adaptive charging) is approximately 66.67 minutes. This indicates the charging time has reduced. FIG. 5C illustrates the variation of capacity with cycle life for both the standard CCCV protocol and the adaptive charging protocol. FIG. 5D illustrates the variation of the aging parameter of the battery with cycle life. It can be observed that both the CCCV and adaptive profiles attain the same capacity at the end of 500 cycles.

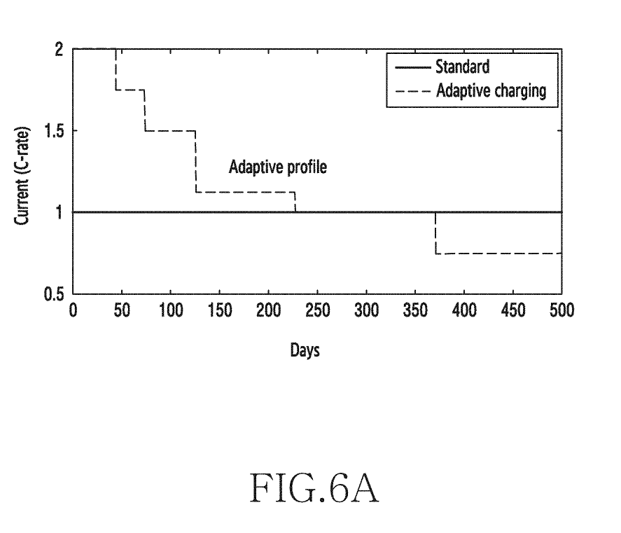

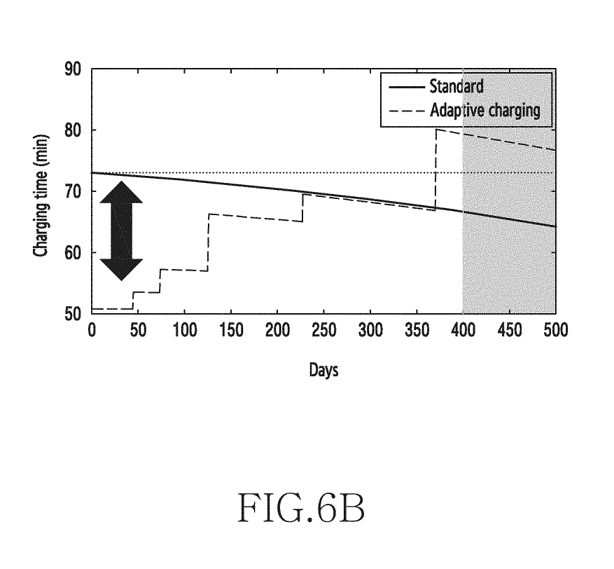

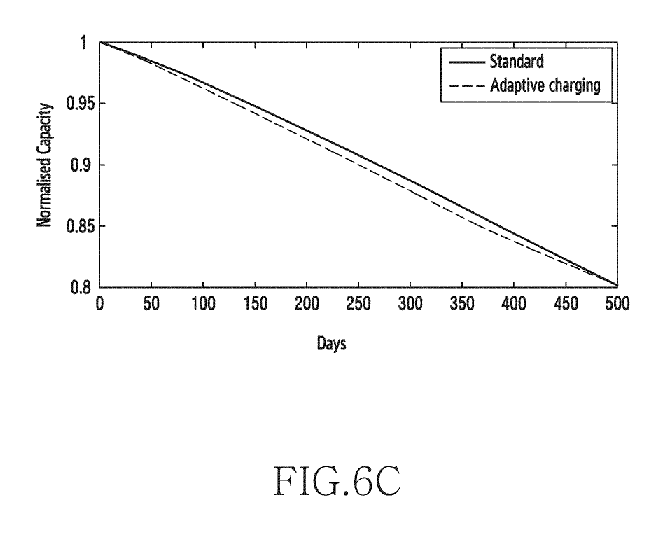

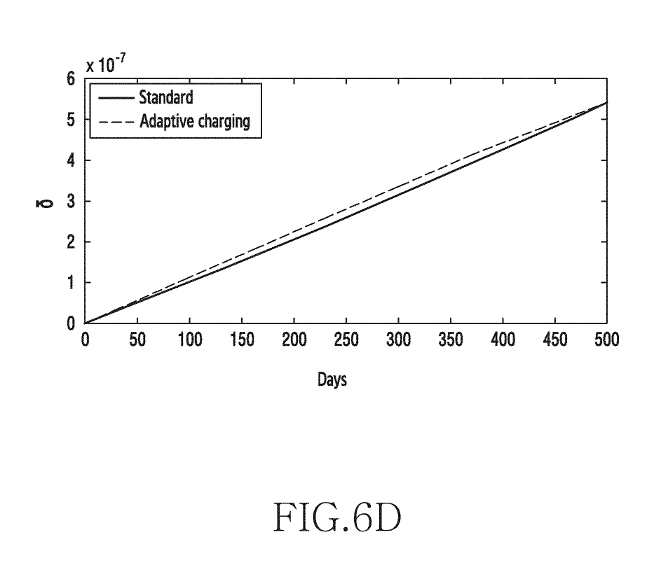

FIGS. 6A, 6B, 6C, and 6D illustrate example scenarios depicting the advantages of adaption of different charging profiles for charging the battery over time according to various embodiments of the present disclosure.

Referring to FIGS. 6A to 6D, here it is considered that battery 103 is put through 1 charge/discharge cycle per day. Of the days under consideration (500, in this example), the user has assigned fast charging for 400 days and does not give any importance to the last 100 days. FIG. 6A illustrates the optimal charging profile over cycle life of the battery. In this case, the adaptive charging rate of the CCCV protocol determined is shown. It can be computed from FIG. 6B that the average charging time for the first 400 days using standard CCCV protocol is approximately 70.19 minutes. It can be computed from FIG. 6B that the average charging time for the first 400 days using various embodiments as disclosed herein is approximately 64.04 minutes. The charging time for 400 days using standard CCCV protocol lower than the charging time for 400 days using adaptive CCCV protocol means reduced charging time and improved user satisfaction. This indicates the charging time has reduced. FIG. 6C illustrates the variation of capacity with cycle life for both the standard CCCV protocol and the adaptive charging protocol. FIG. 6D illustrates the variation of the aging parameter of the battery with cycle life.

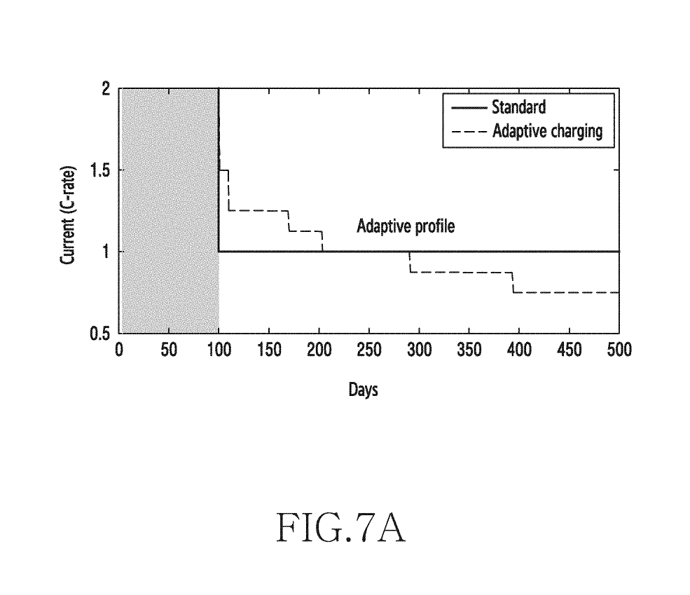

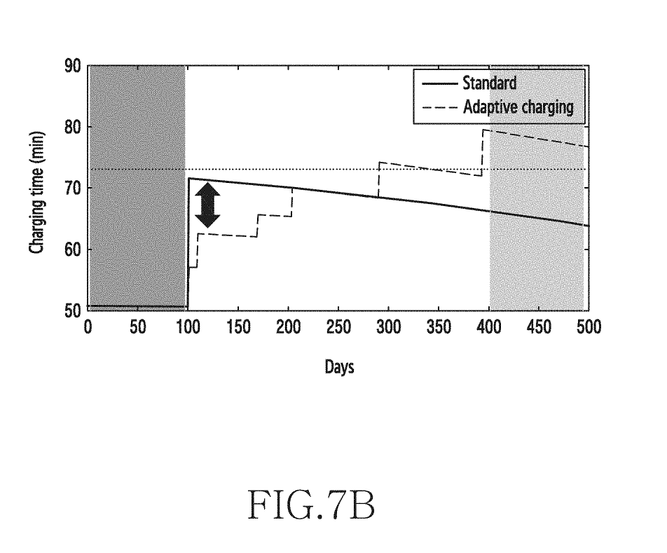

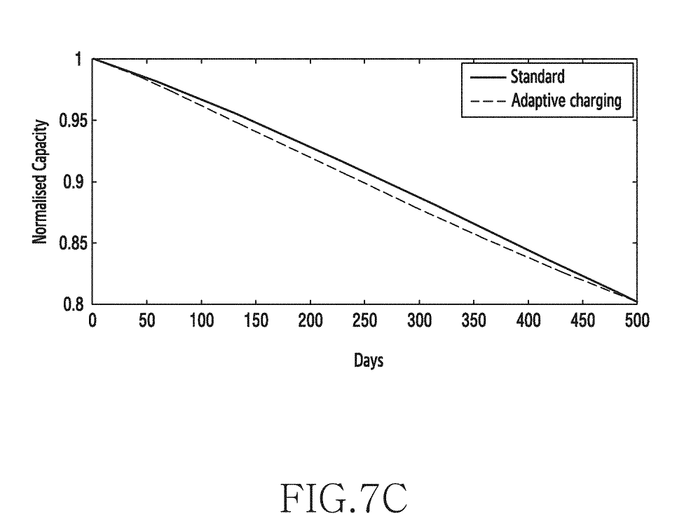

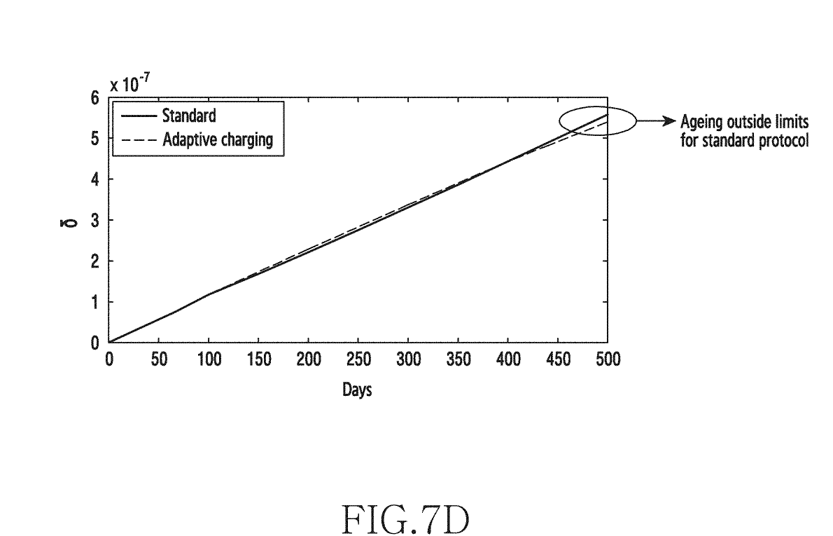

FIGS. 7A, 7B, 7C, and 7D illustrate example scenarios depicting the advantages of adaption of different charging profiles for charging the battery over time according to various embodiments of the present disclosure.

Referring to FIGS. 7A to 7D, here it is considered that battery 103 is put through 1 charge/discharge cycle per day. Of the days under consideration (500, in this example), the user has set the charging rate for first 100 days at twice the normal C (charging) rate, expects fast charging for 400 days and does not give any importance to the last 100 days. FIG. 7A illustrates the optimal charging profile over cycle life of the battery. In this case, the adaptive charging rate of the CCCV protocol determined is shown. It can be computed from FIG. 7B that the average charging time for the first 400 days using standard CCCV protocol is approximately 64.55 minutes and the battery ages beyond the threshold degradation measure in 485 days. It can be computed from FIG. 7B that the average charging time for the first 400 days using various embodiments as disclosed herein is approximately 64.17 minutes and the battery has not aged beyond the threshold degradation measure in 500 days. The charging time for 400 days using standard CCCV protocol lower than the charging time for 400 days using adaptive CCCV protocol means reduced charging time meeting requirements and improved user satisfaction. This indicates the charging time has reduced. FIG. 7C illustrates the variation of capacity with cycle life for both the standard CCCV protocol and the adaptive charging protocol. FIG. 7D illustrates the variation of the aging parameter of the battery with cycle life.

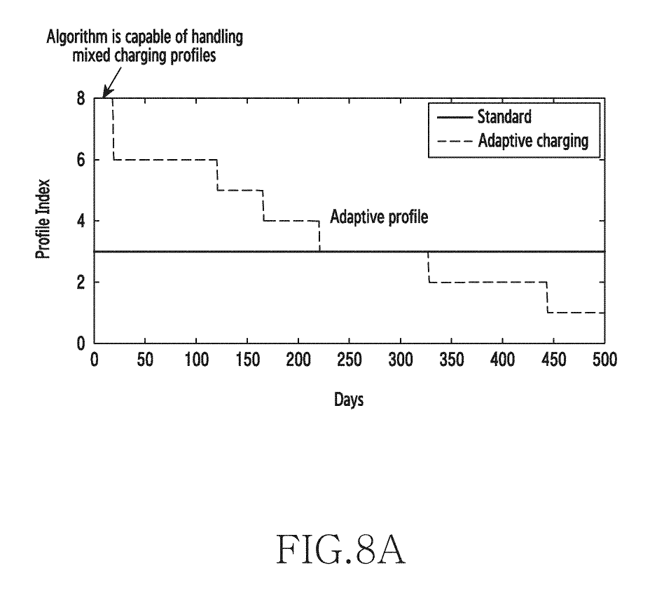

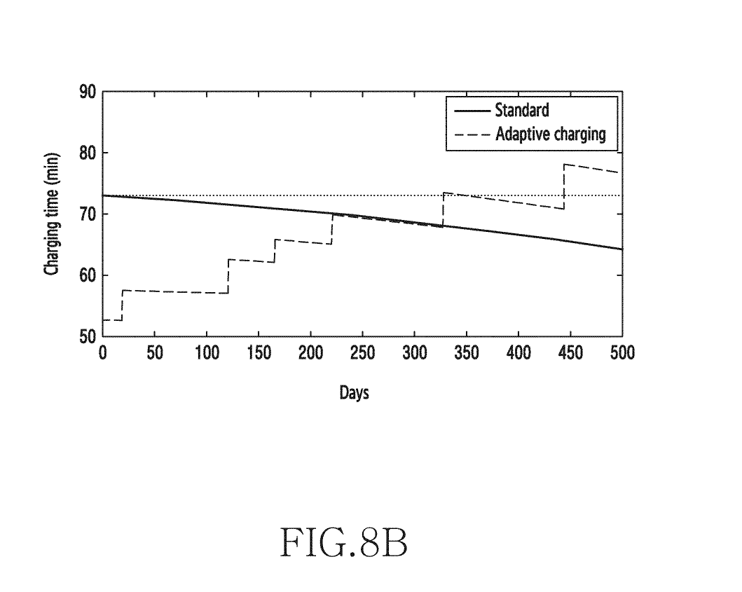

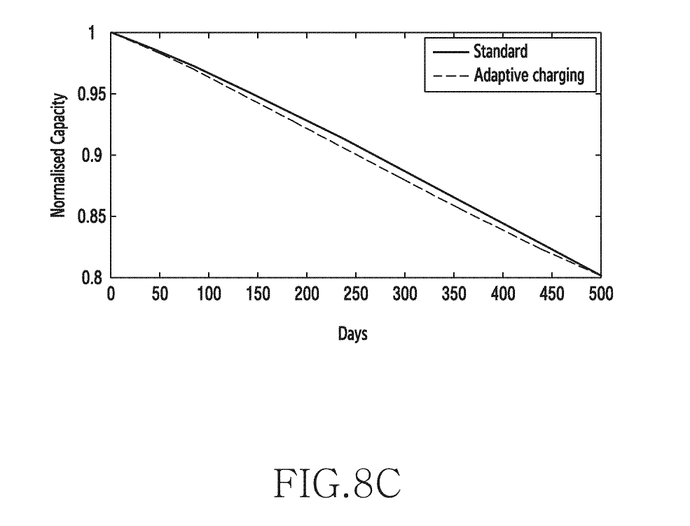

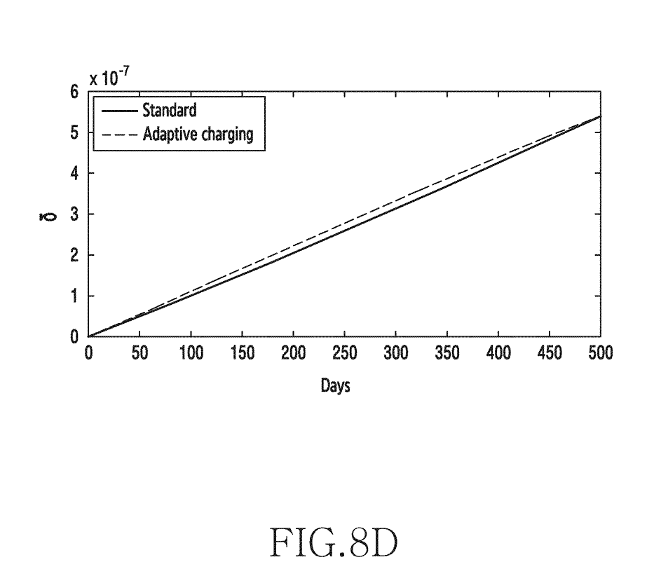

FIGS. 8A, 8B, 8C, and 8D illustrate example scenarios depicting the advantages of adaption of different charging profiles for charging the battery over time according to various embodiments of the present disclosure.

Referring to FIGS. 8A to 8D, here it is considered that battery 103 is put through 1 charge/discharge cycle per day. Of the days under consideration (500, in this example), the user has assigned equal priority to the charging time of all the days. Also consider that mixed charging profiles are used as depicted in Table 1.

TABLE 1

| Profile index | Profile |
|---|---|
| 1 | 0.75 C CCCV |
| 2 | 0.875 C CCCV |
| 3 | a1C CCCV |
| 4 | 1.125 C CCCV |
| 5 | 1.25 C CCCV |
| 6 | 1.5 C CCCV |
| 7 | MSCC 1.75 C (4.2 V)-1.0788 C (4.2 V)-0.6896 C (4.2 V) |
| 8 | MSCC 2 C (4.2 V)-1.2187 C (4.2 V)-0.7742 C (4.2 V) |

FIG. 8A illustrates the optimal charging profile index over cycle life of the battery. In early days that have highest profile index, algorithm is capable of handling mixed charging profiles. FIG. 8B illustrates the time required for charging for the mixed charging profiles and the adaptive charging profiles over the 500 days. FIG. 8C illustrates the variation of capacity with cycle life for both the standard CCCV protocol and the adaptive charging protocol. FIG. 8D illustrates the variation of the aging parameter of the battery with cycle life. Various embodiments herein can account for various charge profiles utilizing varying maximum final voltages (say 4.15V, 4.1V, and so on).

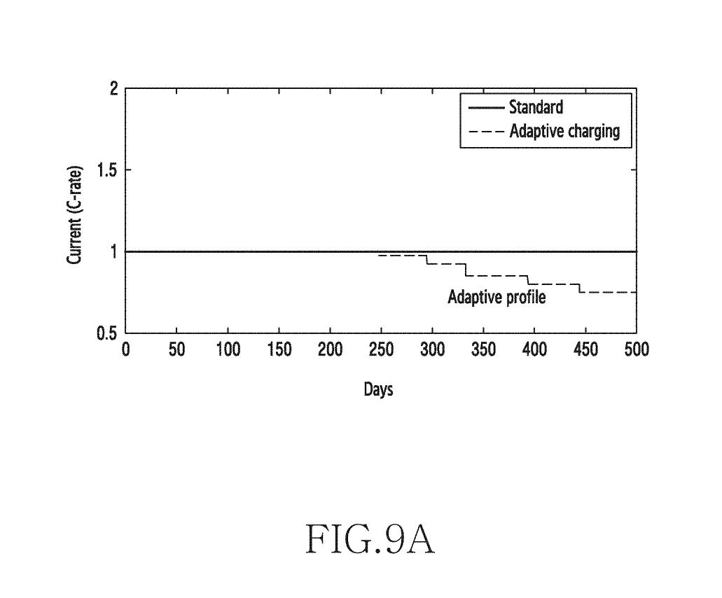

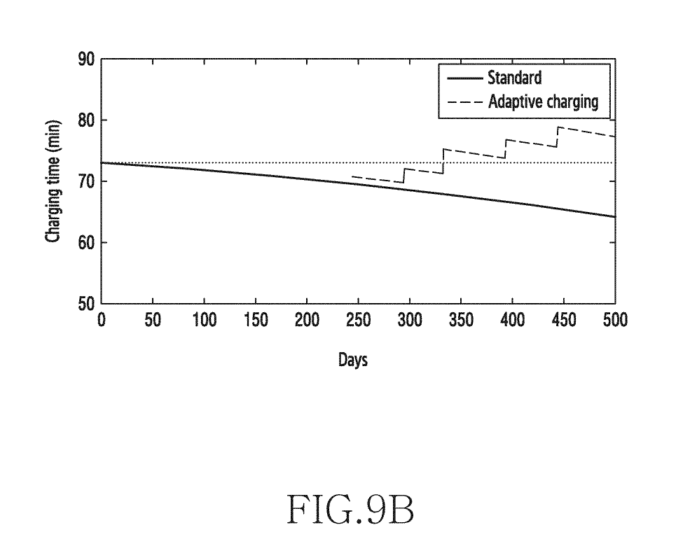

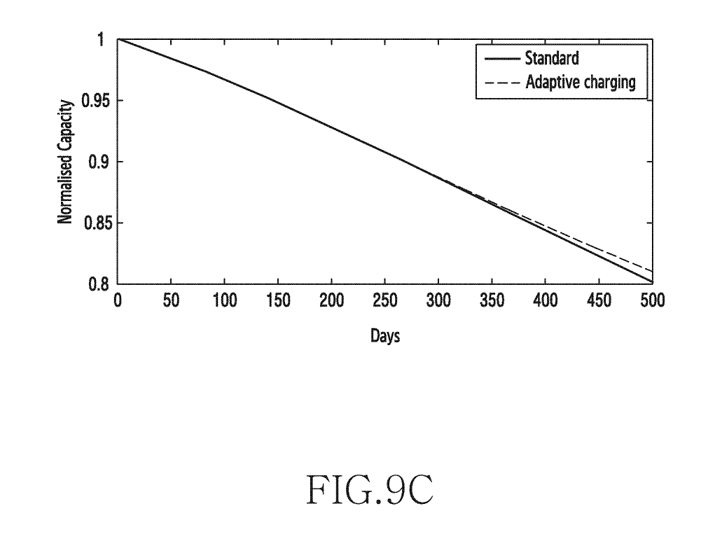

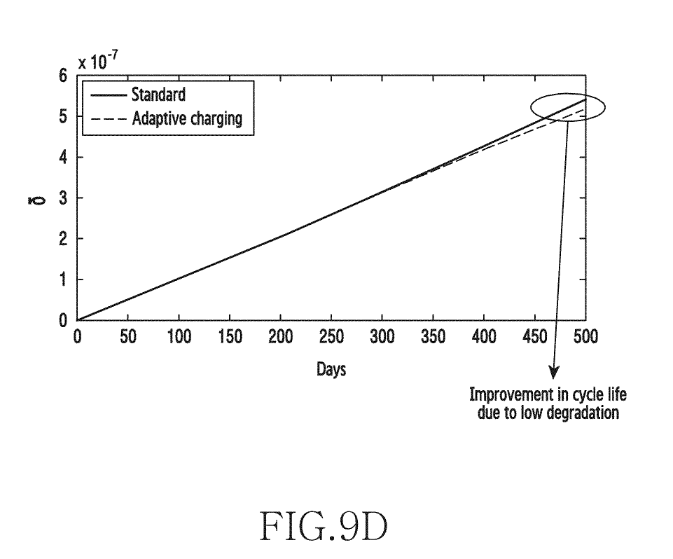

FIGS. 9A, 9B, 9C, and 9D illustrate example scenarios depicting the improvement of life cycle due to adoption of different charging profiles for charging the battery over time according to various embodiments of the present disclosure.

Referring to FIGS. 9A to 9D, here it is considered that battery 103 is put through 1 charge/discharge cycle per day. Of the days under consideration (500, in this example), the user has assigned equal priority to the charging time of all the days and expects a higher life cycle of the battery 103. FIG. 9A illustrates the optimal charging profile over cycle life of the battery, wherein the adaptive charging rates for increasing battery capacity are depicted. FIG. 9B illustrates the time required for charging the battery 103 over the 500 days. FIG. 9C illustrates the variation of capacity with cycle life for both the standard CCCV protocol and the adaptive charging protocol. It can be seen from FIG. 9C that the capacity of the battery at 500 days using standard CCCV protocol is approximately 80.2%. It can be seen from FIG. 9C that the capacity of the battery at 500 days using adaptive charging is approximately 81%. This indicates that capacity at the end of 500 cycles with adaptive charging is higher than the cutoff discharge capacity for an aged cell and so it can be used further. FIG. 9D illustrates the variation of the aging parameter of the battery with cycle life.

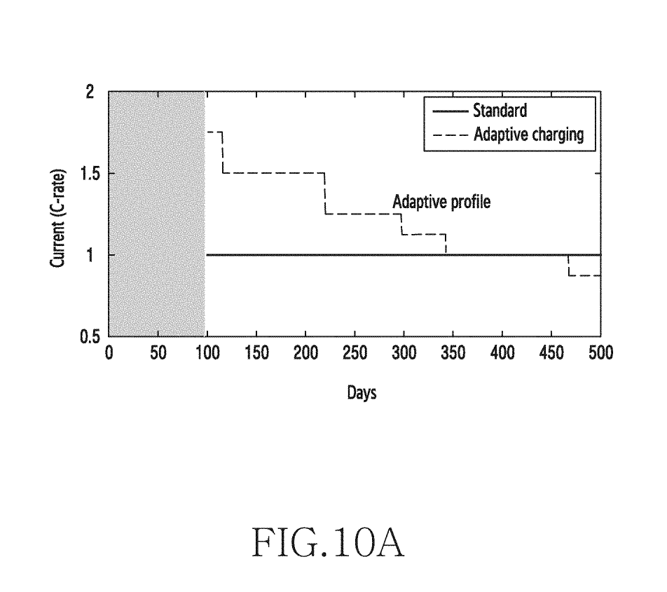

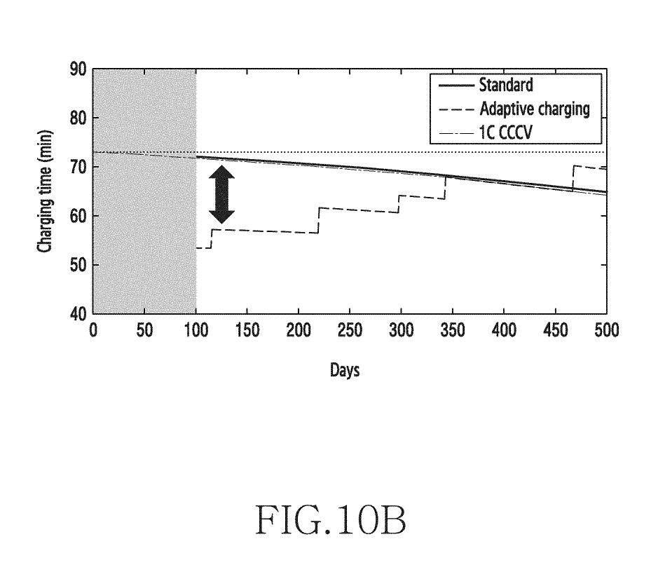

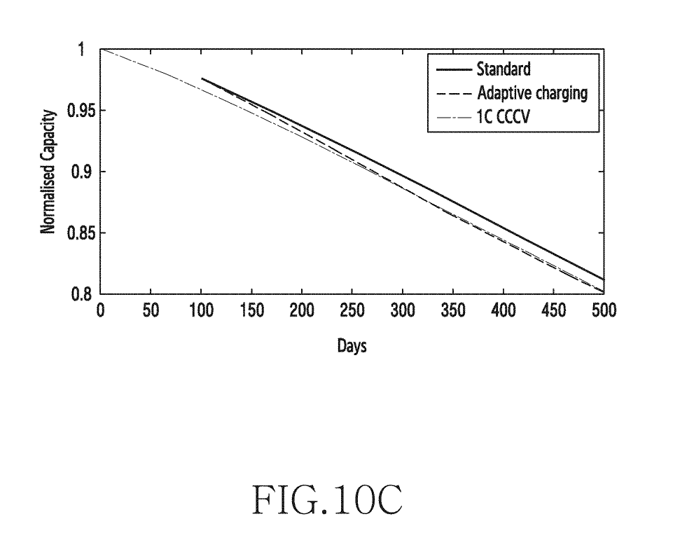

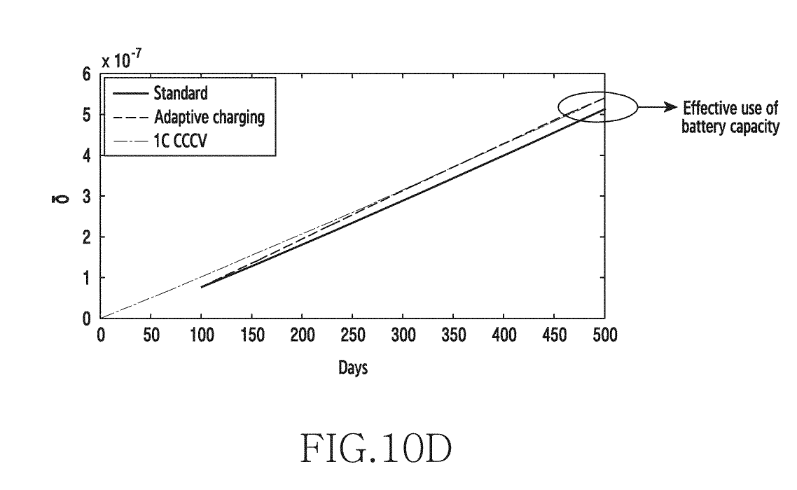

FIGS. 10A, 10B, 10C, and 10D illustrate example scenarios depicting the advantages of adaption of different charging profiles for charging the battery over time according to various embodiments of the present disclosure.

Referring to FIGS. 10A to 10D, here it is considered that battery 103 is put through 1 charge/discharge cycle per day. Of the days under consideration (500, in this example), the user has assigned equal priority to the charging time of all the days. An arbitrary usage profile is used for the first 100 days, as depicted in Table 2.

TABLE 2

| Day No. | Profile | Charge capacity | Discharge capacity |
|---|---|---|---|
| 1-20 | 1 C CCCV | 100% | 100% |
| 21-50 | 1 C CCCV | 100% | 50% |
| 51-100 | 1 C CCCV | 80% | 100% |

FIG. 10A illustrates the optimal charging profile over cycle life of the battery, wherein the adaptive charging rates for increasing battery capacity are depicted. In this case, the adaptive charging rate of the CCCV protocol determined is shown. It can be computed from FIG. 10B that the capacity of the battery at 500 days using standard CCCV protocol is approximately 81.16%. It can be seen from FIG. 10B that the capacity of the battery at 500 days using adaptive charging is approximately 80.19%. Various embodiments herein can use a higher rate of charging, while also meeting the constraints on cycle life and hence charging time can be reduced. The charging time for standard CCCV protocol lower than the charging time for adaptive CCCV protocol means reduced charging time and effective battery use. FIG. 10C illustrates the variation of capacity with cycle life for both the standard CCCV protocol and the adaptive charging protocol. FIG. 10D illustrates the variation of the aging parameter of the battery with cycle life.

The embodiments herein can reduce the time required for charging the battery 103. For example (consider a new battery), the time required for charging the battery 103 may be reduced from 73 minutes to 54 minutes for the first 42 days and consistently reduced charging times compared to standard for more than 6 months.

Adapting the charging rate with cell ageing allows for faster charging of newer batteries, maximization of user satisfaction and meeting the constraints on the minimum number of days a battery must reach before it is becomes completely aged. Re-adaptation of the charging rate based on cell age and actual usage scenario allows for faster charging of new batteries taking into account actual usage, maximization of user satisfaction, and prolonging the life of batteries.

Various embodiments disclosed herein are lightweight and can be implemented without additional hardware. Various embodiments herein enable fast charging of batteries, without affecting the life of the battery. Various embodiments herein can be used with any type of single cycle charging profiles. Various embodiments herein can improve the life of the battery.

The various embodiments disclosed herein can be implemented through at least one software program running on at least one hardware device and performing network management functions to control the elements. The elements shown in FIG. 1 can be at least one of a hardware device, or a combination of hardware device and software module.

Embodiments of the present invention according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform methods of the present invention.

Such software may be stored in the form of volatile or non-volatile storage such as, for example, a storage device like a Read Only Memory (ROM), or in the form of memory such as, for example, Random Access Memory (RAM), memory chips, device or integrated circuits or on an optically or magnetically readable medium such as, for example, a Compact Disc (CD), Digital Video Disc (DVD), magnetic disk or magnetic tape or the like. It will be appreciated that the storage devices and storage media are embodiments of machine-readable storage that are suitable for storing a program or programs comprising instructions that, when executed, implement embodiments of the present invention. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for operating an electronic device, the method comprising:
determining at least one charging rate for a battery;
determining at least one model representing an effect of degradation of the battery and a charging time for at least one charging mechanism;
determining a plurality of charging profiles over a cycle life of the battery based on the at least one model; and
applying the plurality of charging profiles to the battery.

2. The method of claim 1, wherein the determining of the plurality of charging profiles comprises optimising the charging time over a pre-defined number of charging cycles.

3. The method of claim 1, wherein the plurality of charging profiles is determined based on at least one of a charging time of the battery, an age of the battery, at least one option set by a user of the device, usage parameters of the device, user inputs, a temperature, or a power source.

4. The method of claim 1, further comprising:
detecting a user input for customizing the plurality of charging profiles.

5. The method of claim 1, wherein the at least one charging mechanism comprises at least one of constant current-constant voltage (CCCV) charging, multistage constant current (MSCC) charging, linearly decreasing current (LDC) charging, pulsed charging, constant current+pulsed charging (CCPC), pulse charging (PC), variable voltage (VV) charging, constant power (CP) charging, or boost charging (BC).

6. The method of claim 1, wherein the determining the plurality of charging profiles comprises:
determining an optimization problem that utilizes the at least one model; and
solving the optimization problem to minimize a weighted average of the charging time over a pre-defined number of charging cycles.

7. The method of claim 1, wherein the determining of the plurality of charging profiles comprises:
determining an optimization problem that utilizes at least one model; and
solving the optimization problem to minimize a deviation from a standard charging time over a pre-defined number of charging cycles.

8. The method of claim 1, where the applying of the plurality of charging profiles to the battery comprises:
determining an ageing parameter of the battery; and
adapting the plurality of charging profiles based on the ageing parameter.

9. The method of claim 1, where the applying of the plurality of charging profiles to the battery comprises:
determining an order for applying the plurality of charging profiles; and
applying the plurality of charging profiles according to the order.

10. An electronic device comprising:
a battery; and
at least one processor configured to:
determine at least one charging rate for the battery,
determine at least one model representing an effect of degradation of the battery and a charging time for at least one charging mechanism,
determine a plurality of charging profiles over a cycle life of the battery based on the at least one model, and
apply the plurality of charging profiles to the battery.

11. The electronic device of claim 10, wherein the at least one processor is further configured to optimize the charging time over a pre-defined number of charging cycles.

12. The electronic device of claim 10, wherein the plurality of charging profiles is determined based on at least one of a charging time of the battery, an age of the battery, at least one option set by a user of the device, usage parameters of the device, user inputs, a temperature, or a power source.

13. The electronic device of claim 10, wherein the at least one processor is further configured to detect a user input for customizing the plurality of charging profiles.

14. The electronic device of claim 10, wherein the at least one charging mechanism comprises at least one of constant current-constant voltage (CCCV) charging, multistage constant current (MSCC) charging, linearly decreasing current (LDC) charging, pulsed charging, constant current+pulsed charging (CCPC), pulse charging (PC), variable voltage (VV) charging, constant power (CP) charging, or boost charging (BC).

15. The electronic device of claim 10, wherein the at least one processor is further configured to:
determine an optimization problem that utilizes the at least one model, and
solve the optimization problem to minimize a weighted average of the charging time over a pre-defined number of charging cycles.

16. The electronic device of claim 10, wherein the at least one processor is further configured to:
determine an optimization problem that utilizes at least one model; and
solve the optimization problem to minimize a deviation from a standard charging time over a pre-defined number of charging cycles.

17. The electronic device of claim 10, wherein the at least one processor is further configured to:
determine an ageing parameter of the battery; and
adapt the plurality of charging profiles based on the ageing parameter.

18. The electronic device of claim 10, wherein the at least one processor is further configured to:
determine an order for applying the plurality of charging profiles; and
apply the plurality of charging profiles according to the order.

19. An electronic device comprising:
a battery; and
at least one processor configured to:
choose a plurality of charging rates for a duration over a life of the battery,
determine a plurality of charging profiles corresponding to the plurality of charging rates,
adapt at least one of the plurality of charging profiles based on at least one of a battery age, a charging time and a user input, and
apply, to the battery, the plurality of charging profiles including the adapted at least one of the plurality of charging profiles for the duration.

20. The electronic device of claim 19, wherein the at least one processor is further configured to adapt the at least one of the plurality of charging profiles by optimizing the charging time over at least one charging cycle.
